(19) United States
(12) Patent Application Publication
(10) Pub. No.: US 2010/0258068 A1
(43) Pub. Date: Oct. 14, 2010

(54) Spark-ignition type cross-cycle internal combustion engine

(76) Inventor: Lung-tan Hu, Aldergrove (CA)

Correspondence Address: Hu Lung-tan, 25755 48th Avenue, Aldergrove, BC, V4W1J6, CA

(21) Appl. No.: 12/386,045

(22) Filed: Apr. 14, 2009

(51) Int. Cl. F02B 75/20; F02B 33/22; F02B 33/02

(52) U.S. Cl. 123/59.7; 123/70 R; 60/597

(57) ABSTRACT

The present invention provides a spark-ignition type cross-cycle internal combustion engine that can conduct the seven processes of the spark-ignition type cross-cycle operation with gasoline and bio-fuel and natural gas.

### FIELD

1. Field of the Invention

The present invention relates to a spark-ignition type internal combustion engine that operates with the spark-ignition type cross-cycle operation, more particularly relates to an internal combustion engine that utilizes a combination of a male-cylinder and a female-cylinder.

The present invention can be used in the field of power generation and transportation.

2. Background of the Invention

During the past twenty years, my research has focused on the power-to-weight ratio and heat-loss reduction of the compound cylinders configuration; after years of experiments, the cross-cycle operation is developed to achieve a combustion process with minimum heat loss and high power output.

This present invention is one of the possible engine configurations utilizing the cross-cycle concept, further improvements on the cross-cycle operation may be achieved in the near future; and it is my earnest wish that the information disclosed herein could make a contribution to greenhouse gas reduction and engine research.

### SUMMARY OF THE INVENTION

1. The primary objective of the present invention is to provide a spark-ignition type cross-cycle internal combustion engine that is capable of the spark-ignition type cross-cycle operation; said spark-ignition type cross-cycle operation generates a long and stable power output during each expansion process, and the heat loss through the female cylinder wall is relatively lower than that of the current four-stroke engines in the same power output class.

2. The second objective of the present invention is to provide a spark-ignition type cross-cycle internal combustion engine that is capable of fast acceleration and high power output.

### BRIEF DESCRIPTIONS OF THE DRAWINGS

FIG. 1A shows the first process of the spark-ignition type cross-cycle of the first embodiment.

FIG. 1B shows the second process of the spark-ignition type cross-cycle of the first embodiment.

FIG. 1C shows the third process of the spark-ignition type cross-cycle of the first embodiment.

FIG. 1D shows the fourth process of the spark-ignition type cross-cycle of the first embodiment.

FIG. 1E shows the fifth process of the spark-ignition type cross-cycle of the first embodiment

FIG. 1F shows the sixth process of the spark-ignition type cross-cycle of the first embodiment.

FIG. 1G shows the seventh process of the spark-ignition type cross-cycle of the first embodiment.

FIG. 2 shows the Inline-type single crankshaft configuration of the spark-ignition type cross-cycle engine.

FIG. 3 shows the Inline-type double crankshaft configuration of the spark-ignition type cross-cycle engine.

FIG. 4 shows the L-type double crankshaft configuration of the spark-ignition type cross-cycle engine.

FIG. 5 shows the Flat-type double crankshaft configuration of the spark-ignition type cross-cycle engine.

FIG. 6 shows the twin-male configuration of the spark-ignition type cross-cycle engine.

Table.1 demonstrates an example of the spark-ignition type cross-cycle with a piston-phase-difference of 30 degree.

Table.2 demonstrates an example of the spark-ignition type cross-cycle with a piston-phase-difference of 45 degree.

Table.3 demonstrates an example of the spark-ignition type cross-cycle with a piston-phase-difference of 60 degree.

Table.4 demonstrates an example of the spark-ignition type cross-cycle with a piston-phase-difference of 90 degree.

Table 5 demonstrates an example of the spark-ignition type cross-cycle with a piston-phase-difference of 120 degree.

### DESCRIPTION OF THE PREFERRED EMBODIMENTS

The spark-ignition type cross-cycle internal combustion engine can also be abbreviated as the spark-ignition type cross-cycle engine.

The spark-ignition type cross-cycle consists of seven processes and requires at least one male-cylinder and one female-cylinder to co-act with each other; many cylinder arrangements can be employed with the present invention, however, the first embodiment will explain with the simplest cylinder arrangement, namely the Inline-type single crankshaft configuration.

The piston-phase-difference is a specific term referring to the piston position difference between the male-piston and the female-piston, and said piston-phase-difference of the cross-cycle engine can be adjusted from 30 degree to 120 degree depending on the applications and the material strength of the engine head; As a comprehensive reference, Table.1 to Table.5 are presented to demonstrate the possible alternation of the spark-ignition type cross-cycle operation with various piston-phase-difference configurations; Table.1 demonstrates the spark-ignition type cross-cycle with a piston-phase-difference of 30 degree, Table.5 demonstrates the spark-ignition type cross-cycle with a piston-phase-difference of 120 degree, wherein the smaller phase-piston-difference generally requires higher material strength, Table.2 demonstrates the spark-ignition type cross-cycle with a piston-phase-difference of 45 degree, Table.3 demonstrates the spark-ignition type cross-cycle with a piston-phase-difference of 60 degree, Table.4 demonstrates the spark-ignition type cross-cycle with a piston-phase-difference of 90 degree.

Even though a piston-phase-difference smaller than 30 degree is possible to perform the spark-ignition type cross-cycle, it is not feasible with most of the material currently available, while a piston phase difference of greater than 120 degree will increase the heat loss and impede the exhaust process of the cross-cycle.

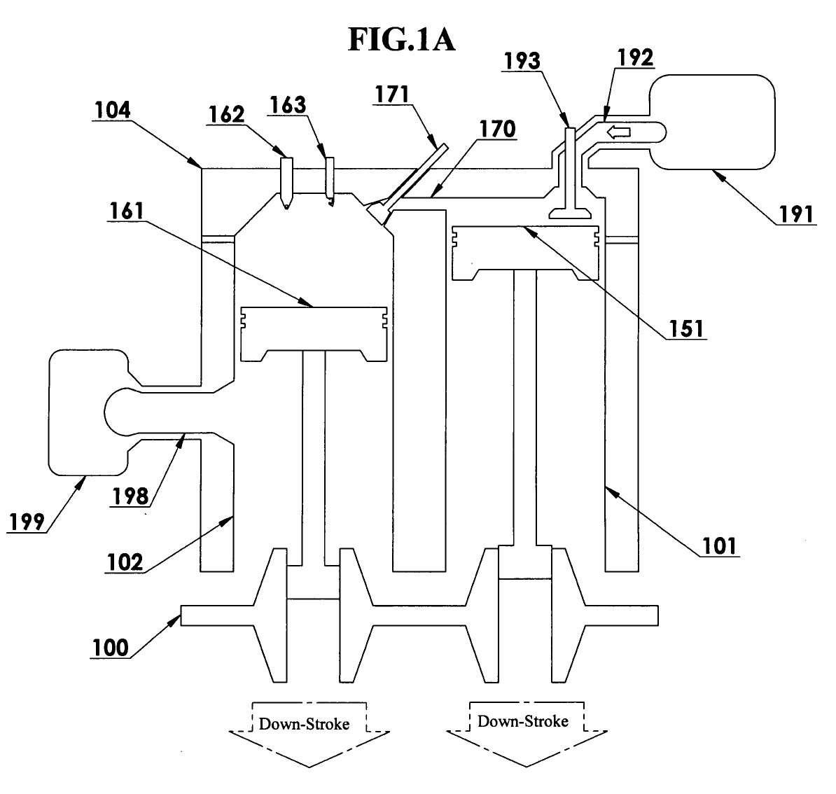

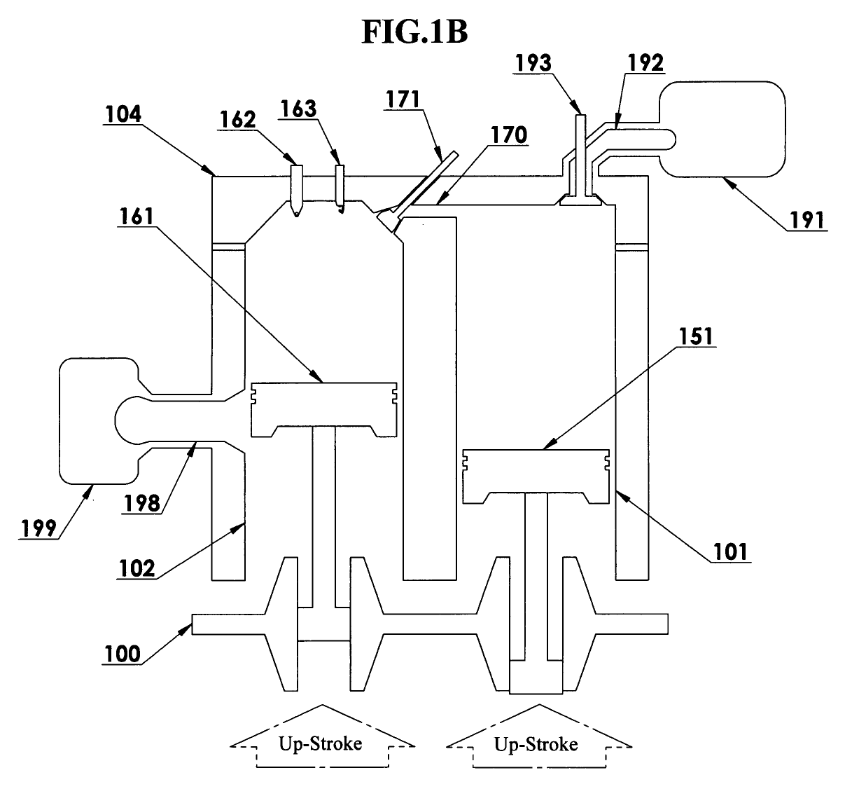

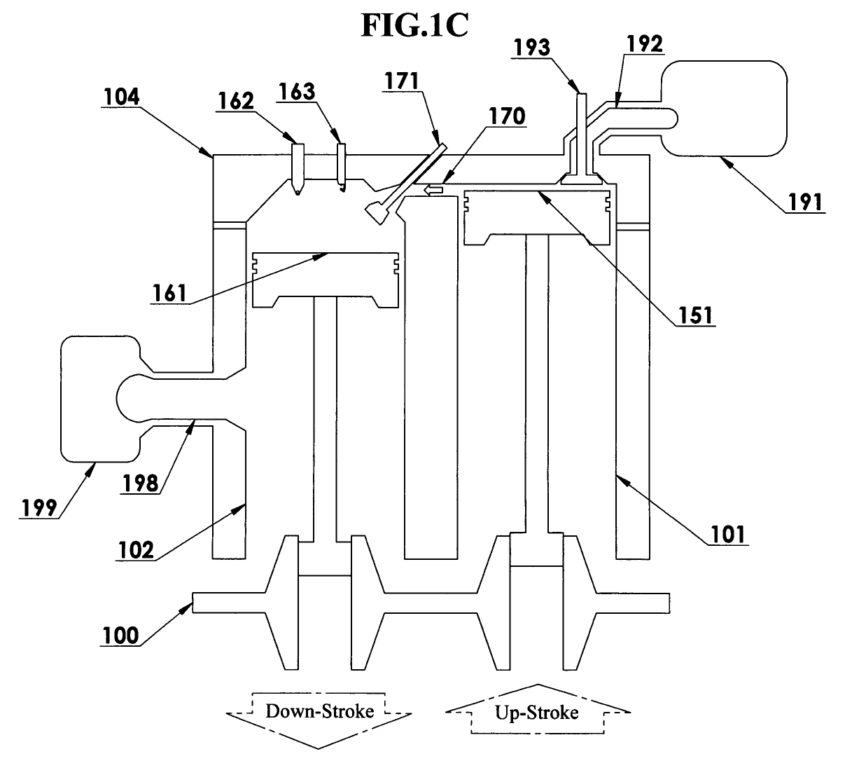

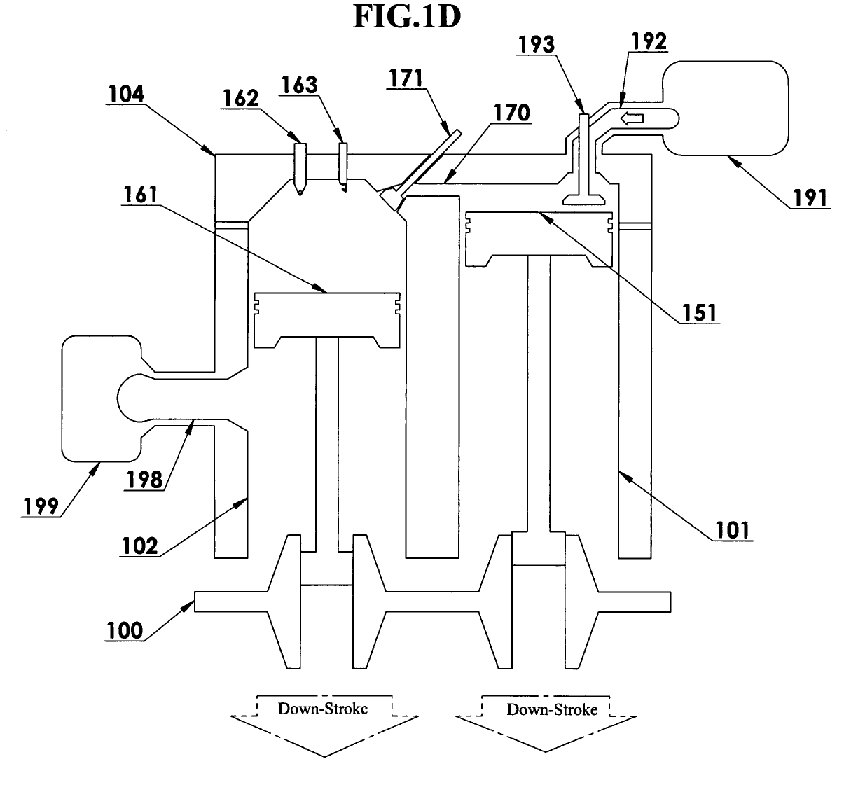

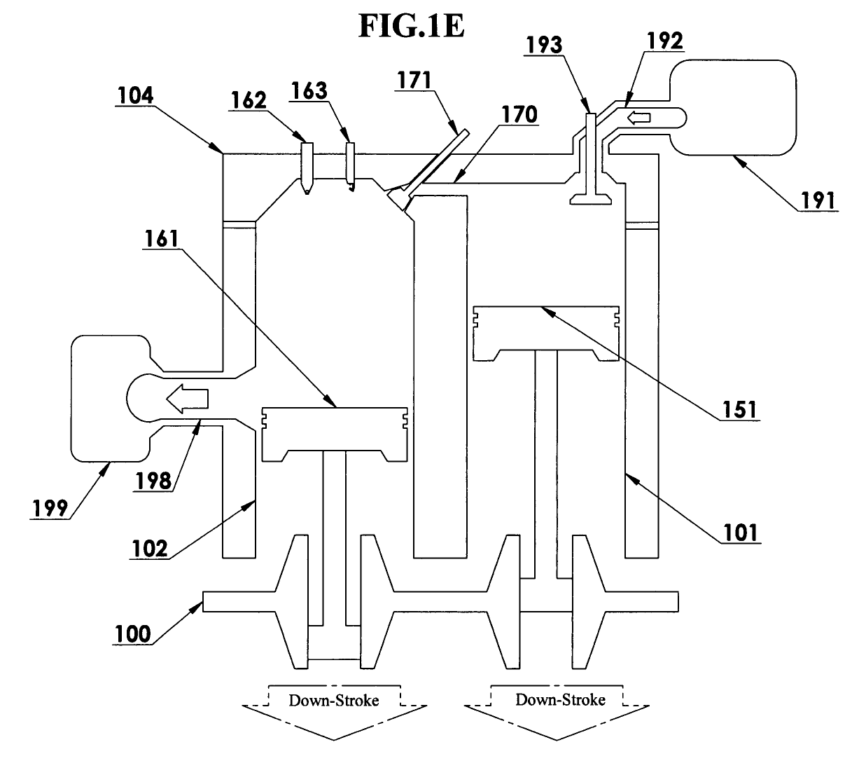

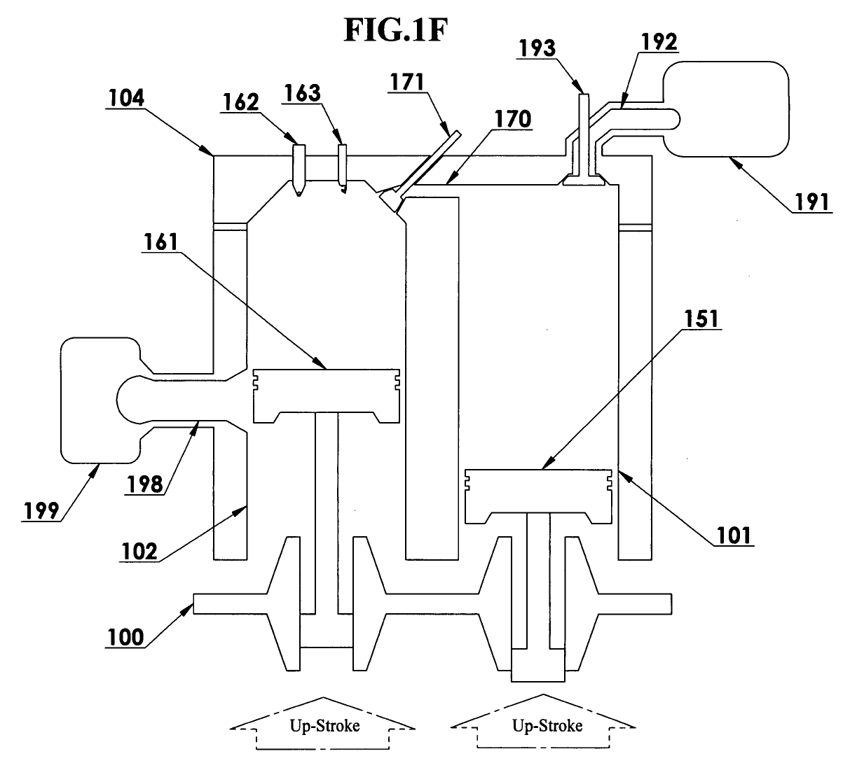

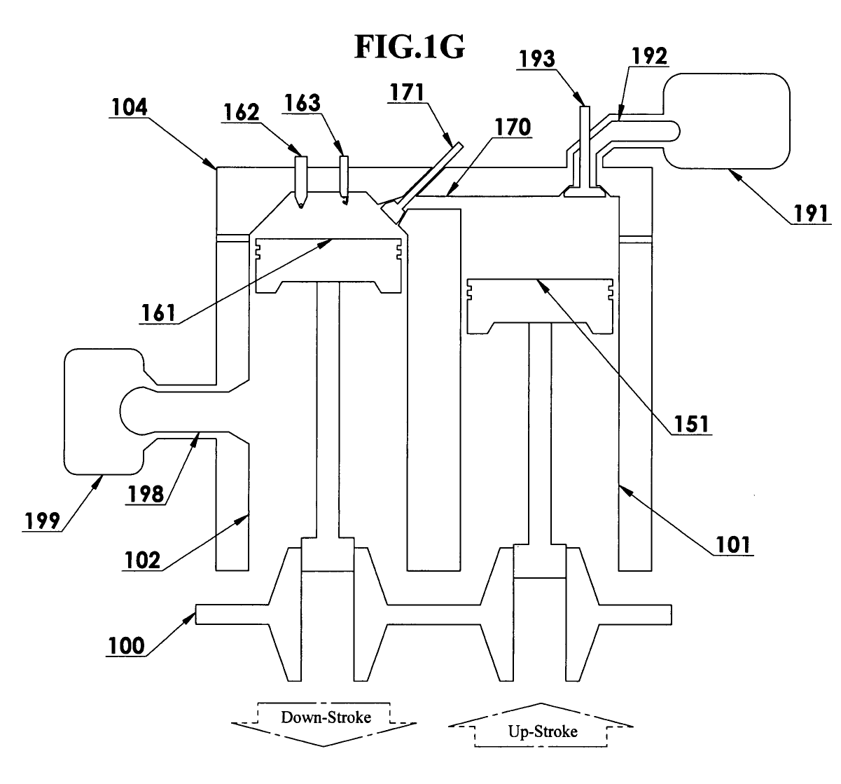

It should be understood that the first embodiment will be using Table.3 and FIG. 1A to FIG. 1G to explain the configuration of the inline-type single crankshaft with a piston phase difference of 60 degree for the demonstration purpose, this specific configuration is only one of the many possible configurations of the present invention,

The specific terminology of the spark-ignition type cross-cycle internal combustion engine will be defined as follows.

The spark-ignition type cross-cycle operation consists of seven processes, and the seven processes are named in the following order as the intake process, the cold-compression process, the injection process, the cold-expansion process, the exhaust process, the hot-compression process, the hot-expansion process.

As shown in FIG. 1A is the spark-ignition type cross-cycle internal combustion engine with the inline-type single crankshaft configuration; the basic components are labeled as follows, the crankshaft 100, the male-cylinder 101, the male-piston 151, the female-cylinder 102, the female-piston 161, the male-intake-port 192, the male-intake-valve 193, the coordinate-port 170, the coordinate-valve 171, the female-exhaust-port 198, the intake-manifold 191, the exhaust-manifold 199, the spark-plug 163, the female-fuel-nozzle 162, the engine head 104.

The coordinate-port 170 provides an air passage from the male-cylinder 101 to the female-cylinder 102, and the coordinate-valve 171 is a valve installed on the female-cylinder end of the coordinate-port 170, therefore the air pressure of the coordinate-port 170 is equal to the air pressure of the male-cylinder 101 when the coordinate-valve 171 is closed.

The female-fuel-nozzle 162 is a fuel nozzle that will directly inject the fuel into the female-cylinder 102 during the sixth process of the spark-ignition type cross-cycle operation, and said female-fuel-nozzle 162 is preferably installed on the female-cylinder section of the engine head 104 in the most cylinder arrangements; it is also possible to install said female-fuel nozzle 162 on the top section of the female cylinder wall.

The fuel used for the present invention can be gasoline, fossil-fuel, bio-fuel, natural gas, LPG, methanol, or other combination of the fuels that require a spark-plug as the ignition means.

The female-exhaust-port 198 is an exhaust port located on the lower section of the female cylinder wall, and which provides an air passage to expel the cold-expanding-medium from the female-cylinder 102 to the exhaust-manifold 199 during the exhaust process of the spark-ignition type cross-cycle operation.

Now referring from FIG. 1A to FIG. 1G for the main concept of the spark-ignition type cross-cycle operation.

FIG. 1A shows the beginning of the first process of the spark-ignition type cross-cycle operation, said first process is called as the intake process; during the first process, the male-intake-valve 193 will open to supply air into the male-cylinder 101 when the male-piston 151 moves toward BDC (bottom dead centre).

FIG. 1B shows the beginning of the second process of the cross-cycle operation, said second process is called as the cold-compression process; during the second process, the male-piston 151 moves toward TDC (top dead centre) to compress the air in the male-cylinder 101.

FIG. 1C shows the beginning of the third process of the cross-cycle operation, said third process is called as the injection process; during the third process, the high-density air of the male-cylinder 101 is injected into the female-cylinder 102 through the coordinate-port 170, and the air pressure of the coordinate-port 170 requires to be higher than the combusting pressure of the female-cylinder 102 prior to the initiation of the injection process.

A more detailed description of said injection process will be provided as follows; the female-cylinder 102 will ignite and expand with the hot-combusting-medium of the previous spark-ignition type cross-cycle before the injection process initiates. As the female-piston 161 moves toward BDC, the combusting pressure of the female-cylinder 102 will decrease to a point that the air pressure of the coordinate-port 170 is greater than the combusting pressure of the female-cylinder 102, at this time the injection process will be initiated by opening the coordinate-valve 171. As the injection process starts, the high-density air is injected into the female-cylinder 102 to mix with the hot-combusting-medium of the female-cylinder 102 to form a cold-expanding-medium inside the female-cylinder 102, and said cold-expanding-medium will expand at a high-density with excessive oxygen content. Generally, the coordinate-valve 171 can remain opening until the male-cylinder 101 initiates the first process of the next spark-ignition type cross-cycle, however it is preferable to shut the coordinate-valve 171 immediately after the air pressure of the coordinate-port 170 is equal to the combusting pressure of the female-cylinder 102 to prevent turbulence. During the injection process, the female-piston 161 will continue to generate power to the crankshaft 100.

FIG. 1D shows the beginning of the fourth process of the spark-ignition type cross-cycle operation, said fourth process is called as the cold-expansion process; the cold-expansion process will initiate when the cold-expanding-medium has formed inside the female cylinder 102; the cold-expanding-medium will generate power to the crankshaft 100 as the female-piston 161 continues to move toward BDC.

FIG. 1E shows the beginning of the fifth process of the spark-ignition type cross-cycle operation, said fifth process is called as the exhaust process; during the exhaust process, a portion of the cold-expanding-medium of the female-cylinder 102 will flow out through the female-exhaust-port 198 when the female-piston 161 slides down the lower section of the female cylinder wall; the cold-expanding-medium will continue to flow out of the female-cylinder until the female-piston 161 moves up and closes the female-exhaust-port 198 on the female cylinder wall. At the end of the exhaust process, at least 10% of the cold-expanding-medium will remain in the female-cylinder 102, and said cold-expanding-medium is a mixture of oxygen and carbon dioxide and nitrogen. The remaining percentage of said cold-expanding medium may vary from about 10% to 70% depending on the rpm and load conditions, and said remaining portion of the cold-expanding-medium in the female-cylinder 102 will be referred to as the remaining-medium after the exhaust process has completed.

FIG. 1F shows the beginning of the sixth process of the spark-ignition type cross-cycle operation, said sixth process is called as the hot-compression process; during the hot-compression process, the female-piston 161 will continue to move toward TDC to compress the remaining-medium inside the female-cylinder 162, at the same time, the female-fuel-nozzle 162 will inject the fuel into the female-cylinder 102 to mix with said remaining-medium. At the end of the hot-compression process, said remaining-medium will be completely mixed with the fuel at an adequate ratio for ignition.

FIG. 1G shows the beginning of the seventh process of the spark-ignition type cross-cycle operation, said seventh process is called as the hot-expansion process; during the hot-expansion process, the spark-plug 163 ignites said remaining-medium when the female-piston 161 is at about TDC position (the spark-ignition timing can range between 35 degree prior to TDC position and 30 degree after TDC position). After the ignition, the hot-combusting-medium inside the female-cylinder 102 will expand at high temperature and high pressure; next, the hot-expansion process will terminate when the combusting pressure of said hot-combusting-medium is lower than the air-pressure of the coordinate-port, then, the injection process of the next spark-ignition type cross-cycle will initiate, and thereby completing the present cycle of the spark-ignition type cross-cycle operation.

The above description is the main concept of the present invention, however, the spark-ignition type cross-cycle operation is relatively complicated than four-stroke internal combustion engines, therefore, an alternative narration with crankshaft reference angle is provided as follows; it should be understood that the crankshaft reference angle described with each process is not a limitation of the process durations or the valve timings; for example, the intake process is referred to as from 0 degree to 180 degree of the crankshaft reference angle, and the cold-compression process is referred to as from 180 degree to 360 degree of the crankshaft reference angle, but the male-intake-valve can close earlier or later than 180 degree of the crankshaft reference angle to block the air passage into the male cylinder according to different applications and usages; therefore, the following narration of the crankshaft reference angle only represents as one of the many possible embodiments of the present invention; even though this following narrative embodiment is not the most ideal configuration in terms of heat-loss reduction, it can be considered as the most comprehensive description for those skilled in the art of four-stroke internal combustion engines.

The following is the narration of the first embodiment with crankshaft reference angle, wherein, Table.3 and FIG. 1A to FIG. 1G can be used as a reference:

The spark-ignition type cross-cycle operation consists of seven processes, and the seven processes are named as the intake process, the cold-compression process, the injection process, the cold-expansion process, the exhaust process, the hot-compression process, the hot-expansion process.

For the spark-ignition type cross-cycle engine configured with the piston-phase-difference of 60 degree as in Table.3, the male-piston 151 is at TDC position at 0 degree of the crankshaft reference angle, and the male-piston 151 is at BDC position at 180 degree of the crankshaft reference angle and the male-piston 151 is at TDC position at 360 degree of the crankshaft reference angle; the female-piston 161 is at TDC position at 300 degree of the crankshaft reference angle, and the female-piston 161 is at BDC position at 480 degree of the crankshaft reference angle, and the female-piston 161 is at TDC position at 660 degree of the crankshaft reference angle.

The first process, the intake process, is to take in the air into the male-cylinder 151 from approximately 0 degree to 180 degree of the crankshaft reference angle.

The second process, the cold-compression process, is to compress the air inside the male-cylinder 101 with the male-piston 151 from approximately 180 degree to 330 degree of crankshaft reference angle.

The third process, the injection process, is to inject the high-density air of the male-cylinder 101 into the female-cylinder 102 when the combusting pressure of female-cylinder 102 is lower than the air pressure of the coordinate-port 170, thereby forming a cold-expanding-medium in the female cylinder 102; said injection process will take place from approximately 330 degree to 360 degree of the crankshaft reference angle (said injection process will initiate after the ignition in any cylinder configurations).

The fourth process, the cold-expansion process, is to generate power to the crankshaft 100 with the cold-expanding-medium while the female-piston 161 continues to move toward BDC from approximately 360 degree to 440 degree of the crankshaft reference angle (the end of cold-expansion process is depending on the position and the shape of the female-exhaust-port, 440 degree of the crankshaft reference angle is only for the demonstration purpose in this particular embodiment).

The fifth process, the exhaust process, is to expel up to 90% of the cold-expanding-medium through the female-exhaust-port 198 from approximately 440 degree to 520 degree of the crankshaft reference angle (this duration of the exhaust process is depending on the position and the shape of the female-exhaust-port 198, the actual duration of the exhaust process can vary from 60 degree to 180 degree for the different applications). The remaining portion of said cold-expanding-medium in the female-cylinder 102 will be referred as the remaining-medium after the exhaust process has completed.

The sixth process, the hot-compression process, is to compress said remaining-medium inside the female-cylinder 102 from approximately 520 degree to 660 degree of the crankshaft reference angle, and at the same time the female-fuel-nozzle 162 will inject an adequate amount of fuel to mix with the remaining-medium to prepare for ignition.

The seventh process, the hot-expansion process, is to ignite the remaining-medium with the spark-plug 163 installed in the female-cylinder, and next the hot-combusting-medium will push the female-piston 161 down to generate power from approximately 660 degree to 690 degree of the crankshaft reference angle. At approximately 690 degree of the crankshaft reference angle, the combusting pressure of the female-cylinder 102 will drop to a pressure less than the air pressure of the coordinate-port 170 (the actual timing of this moment may vary according to the intake amount of the male-cylinder and the engine load condition), at this time, the injection process of the next spark-ignition type cross-cycle operation will take over and complete the present cycle of the spark-ignition type cross-cycle operation.

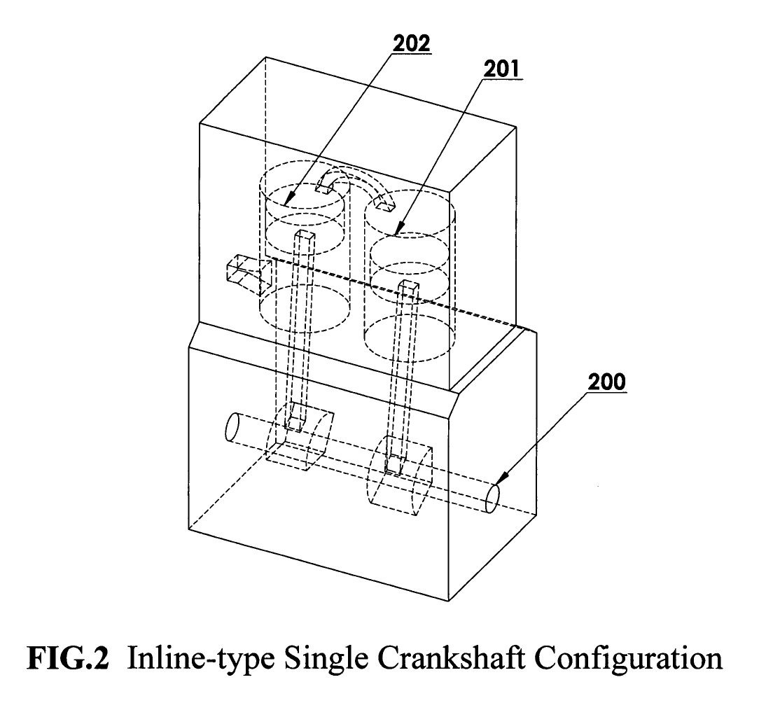

Now referring from FIG. 2 to FIG. 6 to demonstrate the alternative cylinder configurations of the spark-ignition type cross-cycle engine; as these drawing are only for demonstrating the different cylinder configurations, detailed components of the spark-ignition type cross-cycle engine are not shown, and these drawings do not represent the ignition sequence or the crankshaft balancing; the ignition sequence and the crankshaft balancing will not be discussed here since the related knowledge is common to those skilled in the art of internal combustion engines.

FIG. 2 shows the Inline-type single crankshaft configuration of the spark-ignition type cross-cycle engine, wherein the male-cylinder 201 and the female-cylinder 202 will share the power output with a common crankshaft 200; this configuration can further extend to the inline-type single crankshaft configurations and the V-type single crankshaft configurations and the H-type single crankshaft configurations, wherein multiple sets of the female-cylinders and male-cylinders will share and operate with a common crankshaft 100.

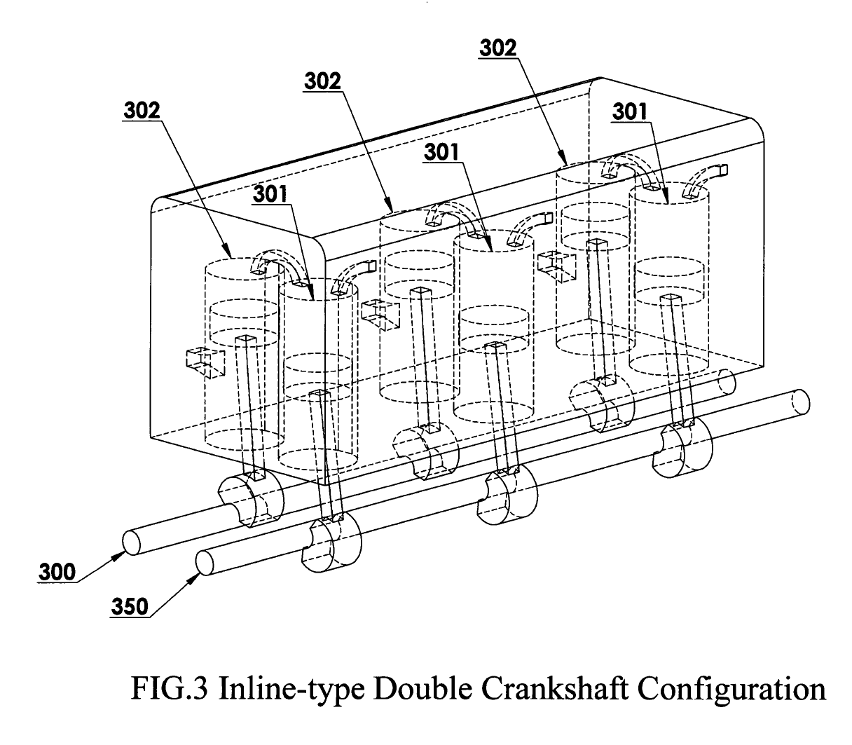

FIG. 3 shows the Inline-type double crankshaft configuration of the spark-ignition type cross-cycle engine, wherein all the male-pistons will reciprocate with a male-crankshaft 300, while all the female-pistons will reciprocate with a female-crankshaft 350. Each male-cylinder 301 and its corresponding female cylinder 302 can also be disposed at an angle for balancing purpose or minimizing the space required; for those cylinder arrangement that disposed at an angle other than 180 degree and 90 degree can be called as the A-type double crankshaft configurations; all the double crankshaft configurations can utilize the synchronizing means such as belt or chains or gears to rotate the male-crankshaft and the female-crankshaft at the same rotation speed.

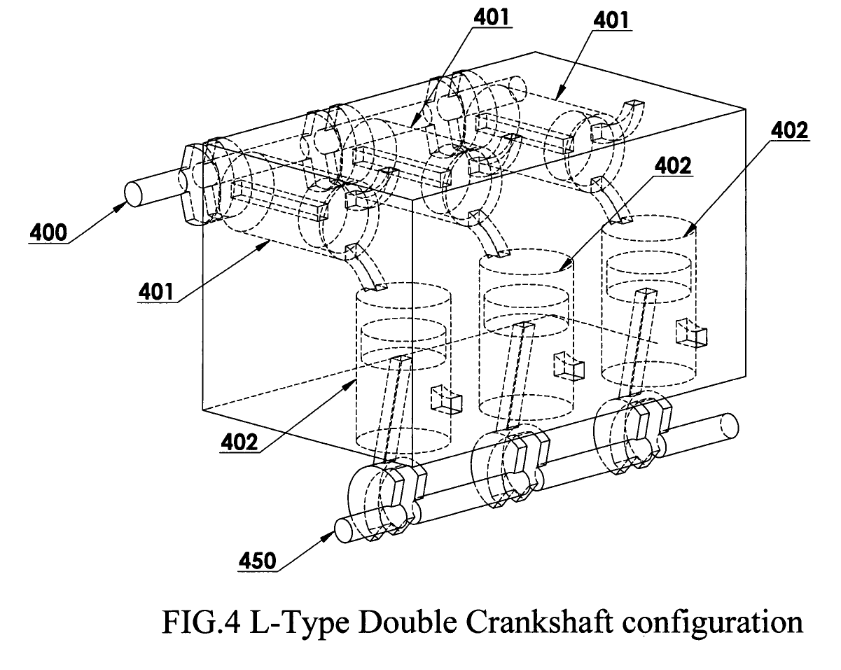

FIG. 4 shows the L-type double crankshaft configuration of the spark-ignition type cross-cycle engine, wherein, all the male-pistons will reciprocate with a male-crankshaft 400, and all the female-pistons will reciprocate with a female-crankshaft 450, wherein each female-cylinder 402 and its corresponding male-cylinder 401 are disposed at 90 degree.

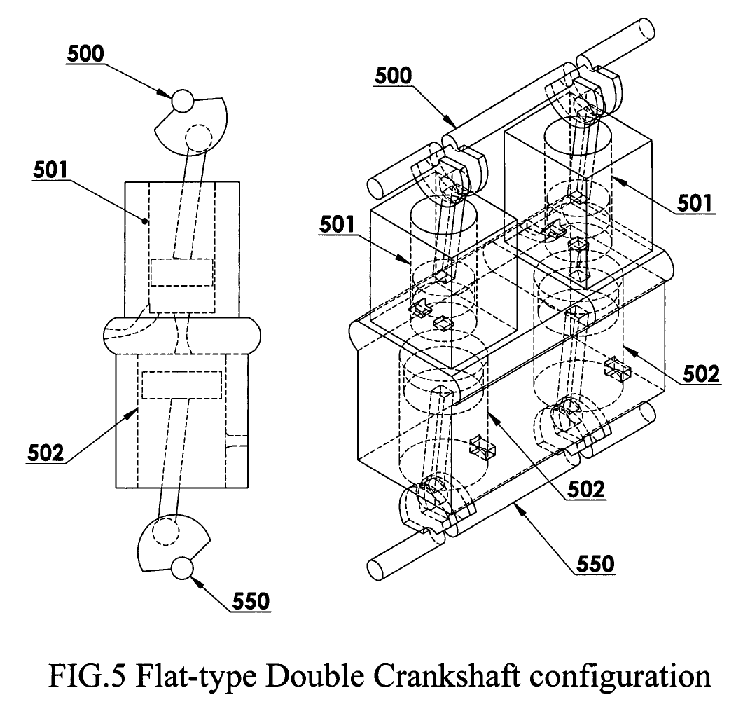

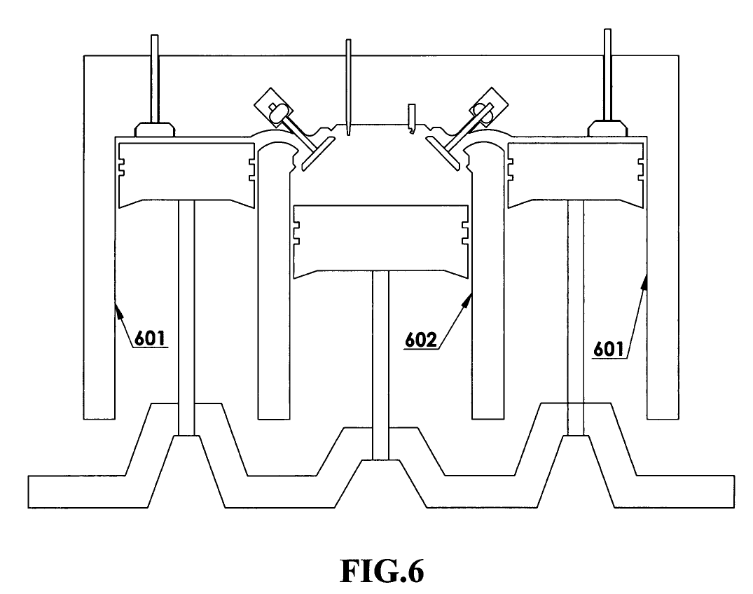

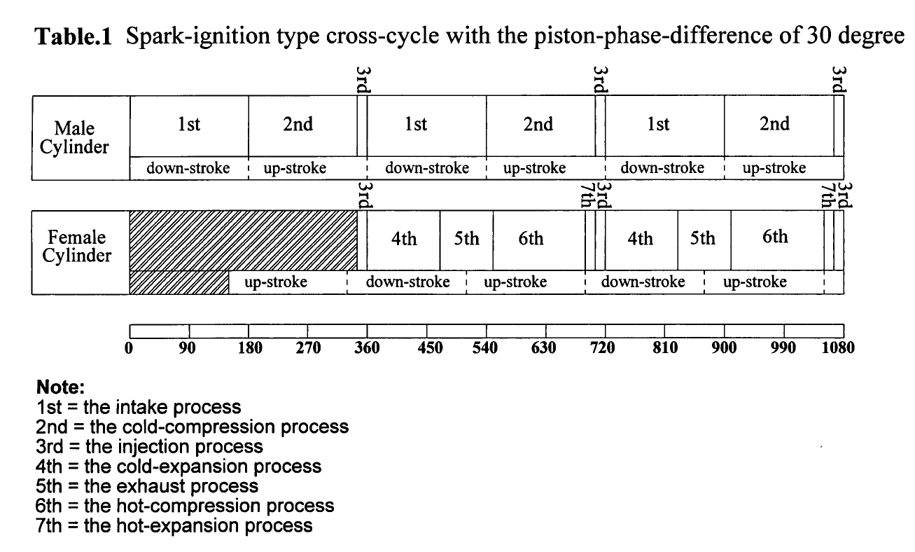

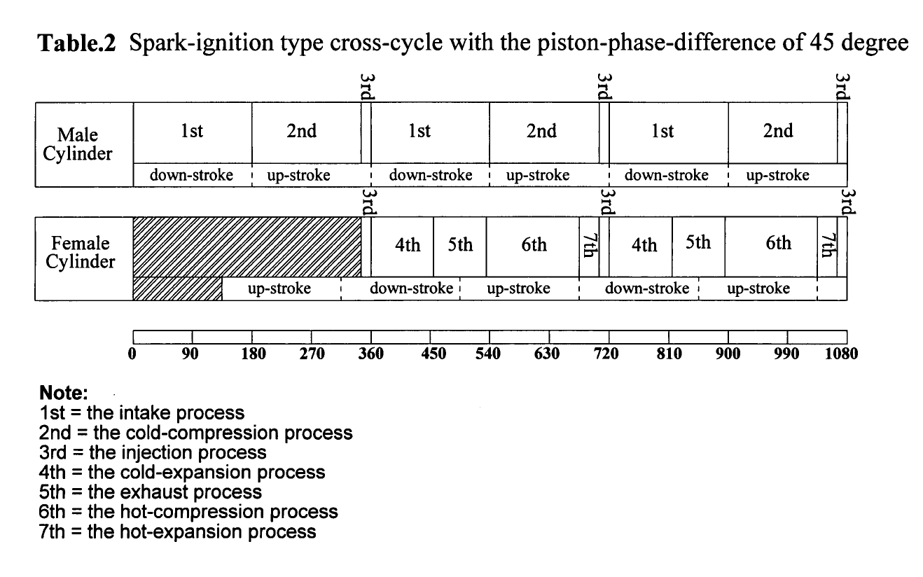

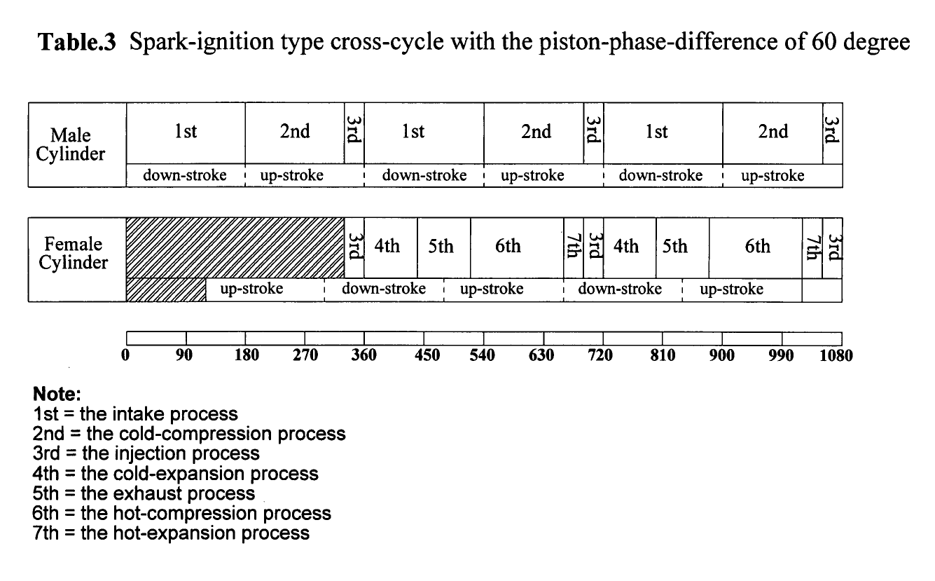

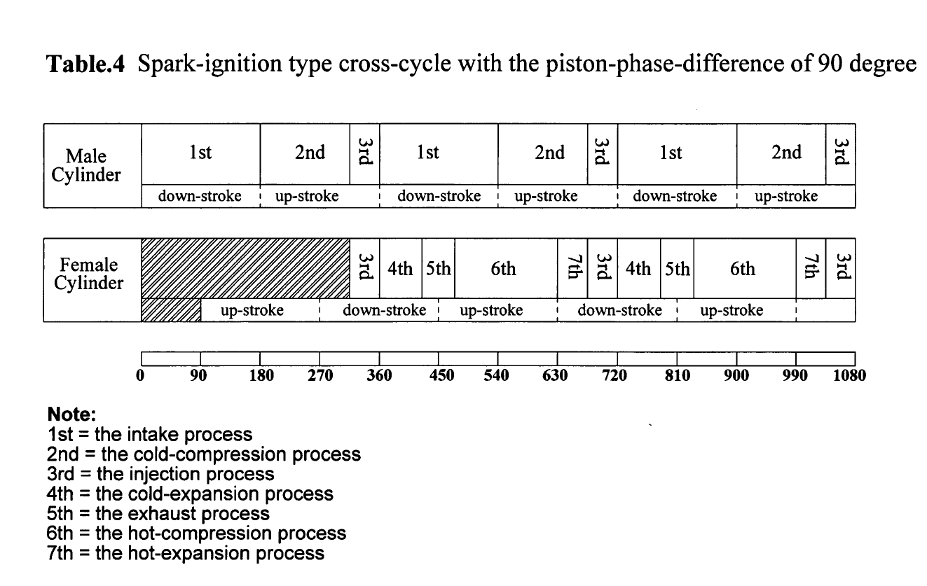

FIG. 5 shows the Flat-type double crankshaft configuration, wherein the all the male-piston will reciprocate with a male-crankshaft 500, and all the female-piston will reciprocate with a female-crankshaft 550, and the centre of each female-cylinder 502 is collinear to the centre of its corresponding male-cylinder 501, such configuration can have a coordinate-port located near the center of the female-cylinder, therefore, the turbulence can be minimized compared to other cylinder arrangements. An off-centre configuration can also be used for the ease of production and valve arrangements, wherein each male-cylinder is disposed in 180 degree with its corresponding female-cylinder with an off-set distance.

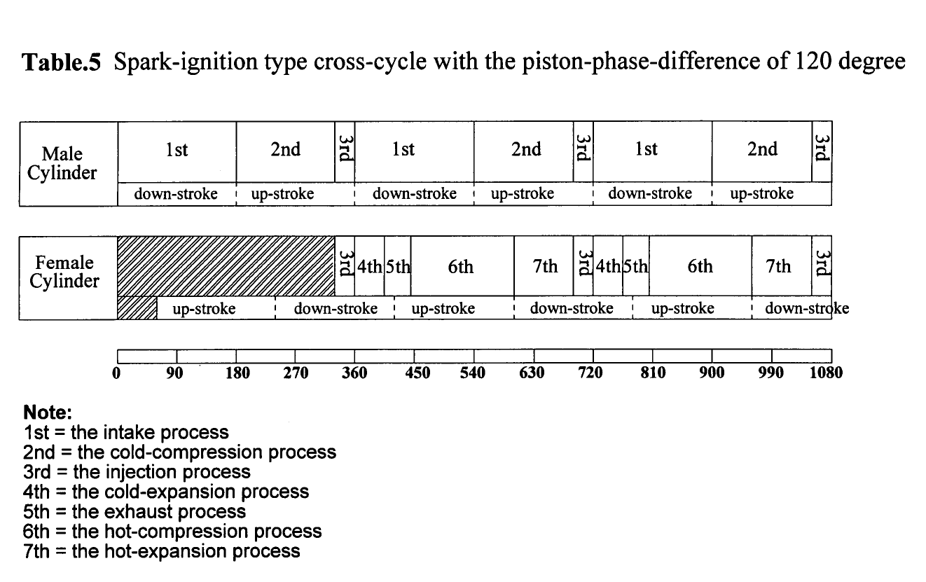

FIG. 6 shows a twin-male configuration of the spark-ignition type cross-cycle engine, wherein one female-cylinder 601 is coupled with two male-cylinders 602, wherein said two male-cylinders 602 will both inject the high-density air into the female-cylinder 601 during the injection process; the twin-male cylinder configuration can improve the overall performance of the injection process by decreasing the hot spots and overall temperature of the engine head. Said two male-cylinders are preferably configured at the exact same phase to initiate the injection process at the same time, however, it is possible to have a small phase difference of up to 45 degree for the two male-cylinders for some large engine applications.

The coordinate-valve can be constructed as a type of swing-check valves or spring-check valves, wherein the coordinate-valve will be actuated with the high-density air of the coordinate-port when the air pressure of the coordinate-port is greater than the combined force of the combusting medium of the female-cylinder and the spring tension on the coordinate-valve.

The coordinate-valve can also be constructed as an enclosed valve, wherein the spring and the valve body of the coordinate-valve are concealed inside the coordinate-port or in a concealed space with an equal pressure of the coordinate-port, thus preventing the high-density air from leaking out of the coordinate-port.

The coordinate-valve can also be actuated with a variable-timing-camshaft, so that the valve open duration and valve schedule can be adjusted to maximize the engine performance for different load conditions.

The coordinate-valve can also be a hydraulic-valve or an electromagnetic-valve. The coordinate-port can also be constructed with multiple coordinate-valves, wherein the coordinate-port can inject the high-density air into the female-cylinder at multiple spots to improve the overall performance of the injection process.

The duration of the exhaust process can range from 60 degree to 180 degree of crankshaft rotation according to the position and the shape of the female-exhaust-port. At least 10% of the cold-expansion-medium will be required to remain in the female-cylinder when the exhaust process has completed.

The duration of the injection process of the spark-ignition type cross-cycle operation can vary from 3 degree to 90 degree of crankshaft rotation for different engine operation conditions, wherein the coordinate-valve can start to open after the air pressure of the coordinate-port is higher than the combusting pressure of the female-cylinder, while the coordinate-valve can start to close after the air pressure of the coordinate-port is equal to the pressure of the female-cylinder. The duration of the injection process of the spark-ignition type cross-cycle operation can be even shortened for the low-rpm large engines, wherein the shorter duration can result in a better heat-loss-reduction.

Among all the possible configurations of the present invention, the preferable configurations are the ones that can minimize the duration of the hot-expansion process and the injection process without damaging the engine components, thereby increasing the duration of the cold-expansion process to reduce the heat loss resulted from the spark-ignition type cross-cycle operation.

The ignition of the female-cylinder can be initiated at any point between 35 degree prior to TDC position and 30 degree after TDC position with one or more spark plugs; wherein, for the configuration with multiple spark plugs, the ignition can be initiated in multiple spots inside the female-cylinder.

10% to 70% of the cold-expanding-medium will remain in said female-cylinder at the end of the exhaust process, and the duration of the exhaust process can range from 60 degree to 120 degree of crankshaft rotation; the minimum duration is from 30 degree before the BDC position of said female-piston to 30 degree after the BDC position of said female-piston, while the maximum duration is from 90 degree before the BDC position of said female-piston to 90 degree after the BDC position of said female-piston.

1. A spark-ignition type cross-cycle internal combustion engine comprising at least one set of a male-cylinder and a female-cylinder for performing the seven processes of the spark-ignition type cross-cycle operation;
a) said male-cylinder includes a reciprocating male-piston, and said female-cylinder includes a reciprocating female-piston;
b) said spark-ignition type cross-cycle consists of seven processes, the air is supplied into said male-cylinder during the intake process, next the air is compressed inside said male-cylinder during the cold-compression process, next a flow of high-density air is injected into said female-cylinder to form a cold-expanding-medium during the injection process, next said cold-expanding-medium will generate power in said female-cylinder during the cold-expansion process, next a portion of said cold-expanding-medium will be expelled out of said female-cylinder through a female-exhaust-port connected to the lower section of said female-cylinder during the exhaust process, next the remaining portion of said cold-expanding-medium will be mixed with fuel and compressed inside said female-cylinder during the hot-compression process, an adequately fuel-rich remaining-medium will be ignited to generate a hot-expanding-medium in said female-cylinder during the hot-expansion process; the seven processes of the spark-ignition cross-cycle operation will repeat in their corresponding cylinders every 360 degree of the crankshaft rotation;
c) said male-cylinder will perform the intake process during its down-stroke, while said male cylinder will perform the cold-compression process and the injection process during its up-stroke; wherein said male-cylinder will repeat its operation every 360 degree of crankshaft rotation;
d) said female-cylinder will perform the hot-expansion process and the injection process and approximately half of the exhaust process during its down-stroke, while said female-cylinder will perform the remaining half of the exhaust process and the hot-compression process during its up-stroke; wherein said female-cylinder will repeat its operation every 360 degree of crankshaft rotation;
f) the injection process is initiated by injecting the high-density air of said male-cylinder into said female-cylinder through a coordinate-port when said male-cylinder has an air pressure higher than the combusting pressure of said female-cylinder, wherein said coordinate-port will start to shut with a coordinate-valve when the air pressure of said male-cylinder is about equal to the combusting pressure of said female-cylinder;
g) a portion of the cold-expanding-medium will remain in said female-cylinder at the end of the exhaust process;
h) said female-cylinder comprises at least one spark-plug and one female-fuel-nozzle to ignite the remaining-medium in said female-cylinder; wherein said female-fuel-nozzle will supply fuel into said female-cylinder during the hot-compression process, and said spark-plug will ignite between 35 degree prior to the TDC position of said female-piston and 30 degree after the TDC position of said female-piston.

2. A spark-ignition type cross-cycle internal combustion engine as defined in claim 1, wherein 10% to 70% of the cold-expanding-medium will remain in said female-cylinder at the end of the exhaust process of said spark-ignition type cross-cycle operation; the duration of the exhaust process can range from 60 degree to 180 degree of crankshaft rotation; the minimum duration is from 30 degree before the BDC position of said female-piston to 30 degree after the BDC position of said female-piston, while the maximum duration is from 90 degree before the BDC position of said female-piston to 90 degree after the BDC position of said female-piston.

3. A spark-ignition type cross-cycle internal combustion engine as defined in claim 1, wherein the duration of the injection process can range from 3 degree to 90 degree of crankshaft rotation.

4. A spark-ignition type cross-cycle internal combustion engine as defined in claim 1, wherein said male-piston and said female-piston are arranged with a piston-phase-difference of 30 degree to 120 degree.

5. A spark-ignition type cross-cycle internal combustion engine as defined in claim 1 further comprising multiple sets of male-cylinders and female-cylinders; wherein all the female-pistons and the male-pistons are connected to a common crankshaft, so that said female-cylinders and said male-cylinders can be arranged in V-type cylinder configurations, H-type cylinder configurations, and Inline-type cylinder configurations.

6. A spark-ignition type cross-cycle internal combustion engine as defined in claim 1 further comprising multiple sets of male-cylinders and female-cylinders; wherein, all female-pistons are connected to a female-crankshaft and all male-pistons are connected to a male-crankshaft, so that said female-cylinders and said male-cylinders can be arranged in Inline-type double crankshaft configurations, A-type double crankshaft configurations, Flat-type double crankshaft configurations, and L-type double crankshaft configurations.

7. A spark-ignition type cross-cycle internal combustion engine comprising:
a) a male-cylinder with air-intake means;
b) a female-cylinder with a spark-plug and a female-fuel-nozzle;
c) said female-cylinder and said male-cylinder will together perform the seven processes of the spark-ignition type cross-cycle operation; wherein said seven processes are performed in the following order, the intake process, the cold-compression process, the injection-process, the cold-expansion process, the exhaust process, the hot-compression process, the hot-expansion process;
d) a male-piston reciprocating in said male cylinder, and a female-piston reciprocating in said female cylinder;
e) a piston-phase-difference of 30 degree to 120 degree between said male-piston and said female-piston;
f) a female-exhaust-port connected to the lower section of said female-cylinder, wherein said female-exhaust-port will provide an air passage to an exhaust-manifold when said female-piston slides down the lower section of said female-cylinder;
g) a coordinate-port connecting through said female-cylinder and said male-cylinder, and a coordinate-valve installed on the female-cylinder side of said coordinate port; wherein said coordinate-port will have a direct passage and equal pressure with said male-cylinder when said coordinate-valve is shut;
h) at least 10% of the cold-expansion-medium will remain inside said female-cylinder after the exhaust process, and said female-fuel-nozzle will supply the fuel into said female-cylinder during the hot-compression process, so that a mixture of the fuel and the remaining-medium will be ready for ignition with said spark-plug at the end of the cold-compression process;

8. A spark-ignition type cross-cycle internal combustion engine as defined in claim 7, wherein said male-cylinder will start to inject the high-density air into said female-cylinder when the air pressure of said coordinate-port is higher than the combusting pressure of the hot-combusting-medium in said female-cylinder; said coordinate-valve will start to shut when the air pressure of said coordinate-port is about equal to the pressure in said female-cylinder.

9. A spark-ignition type cross-cycle internal combustion engine as defined in claim 7, wherein the duration of the exhaust process can range from 60 degree to 180 degree of crankshaft rotation, while the duration of the injection process can range from 3 degree to 90 degree of crankshaft rotation.

10. A spark-ignition type cross-cycle internal combustion engine as defined in claim 7, wherein said coordinate-valve can be a type of spring-check-valves or swing-check-valves; said coordinate-valve will be actuated with the high-density air when the air pressure of said coordinate-port is higher than the combined forced of the spring tension and the combusting pressure applied on said coordinate-valve to begin the injection process.

11. A spark-ignition type cross-cycle internal combustion engine as defined in claim 7, wherein said coordinate-valve can be actuated with a variable-timing-camshaft.

12. A spark-ignition type cross-cycle internal combustion engine as defined in claim 7, wherein said coordinate-valve can be a type of electromagnetic-valve or hydraulic-valve.

13. A spark-ignition type cross-cycle internal combustion engine comprising a male-cylinder and a female-cylinder with a piston-phase-difference between 30 degree and 120 degree to operate in the spark-ignition type cross-cycle; said spark-ignition type cross-cycle operation consists of seven processes, the air is supplied into said male-cylinder during the first process, the air is compressed inside said male-cylinder during the second process, a flow of high-density air is injected into said female-cylinder to form a cold-expanding-medium during the third process, said cold-expanding medium will generate power in said female-cylinder during the fourth process, a portion of said cold-expanding-medium will be expelled out of said female-cylinder through an exhaust port connected to the lower section of said female-cylinder during the fifth process, the remaining portion of said cold-expanding-medium will be mixed with fuel and compressed inside said female-cylinder during the sixth process, an adequately rich air-fuel mixture will be ignited with a spark plug to generate a hot-expanding medium in said female-cylinder during the seventh process; the seven processes of said spark-ignition type cross-cycle operation will repeat in their corresponding cylinders every 360 degree of the crankshaft rotation.

14. A spark-ignition type cross-cycle internal combustion engine as defined in claim 13, wherein 10% to 70% of the cold-expanding-medium will be remained in the female-cylinder at the end of each fifth process.

15. A spark-ignition type cross-cycle internal combustion engine as defined in claim 13, wherein the duration of the fifth process can range from 60 degree to 180 degree of crankshaft rotation, while the duration of the third process can range from 3 degree to 90 degree of crankshaft rotation.

16. A spark-ignition type cross-cycle internal combustion engine as defined in claim 13, wherein said female-piston is connected to a female-crankshaft, and said male-piston is connected to a male-crankshaft; said female-crankshaft and said male-crankshaft are coupled with gears or chains or belt to synchronize their rotational speed; said female-cylinder and said male-cylinder can be constructed in A-type double crankshaft configurations, Flat-type double crankshaft configurations, L-type double crankshaft configurations, and Inline-type double crankshaft configurations.

17. A spark-ignition type cross-cycle internal combustion engine as defined in claim 13, wherein said female-piston and said male-piston are connected to a common crankshaft; said female-cylinder and said male-cylinder can be constructed in Inline-type single crankshaft configurations, V-type single crankshaft configurations, and H-type single crankshaft configurations.

18. A spark-ignition type cross-cycle internal combustion engine as defined in claim 13, wherein each female-cylinder can co-act with two male-cylinders to improve the performance of the third process; said two male-cylinders will both inject the high-density air into said female-cylinder during the third process; said two male cylinders can have a phase difference of up to 45 degree between each other.

19. A spark-ignition type cross-cycle internal combustion engine as defined in claim 13, wherein said high-density air of said male-cylinder can be injected through multiple air passages into the female-cylinder to reduce the hot spots and overall temperature of the engine head during the third process.

20. A spark-ignition type cross-cycle internal combustion engine as defined in claim 13, wherein said flow of high-density air is controlled with a spring-check-valve or a swing-check-valve, thereby providing an air passage from said male-cylinder to said female-cylinder when the air pressure of said male-cylinder is higher than the combusting pressure of said female cylinder to initiate the third process.
